(19) United States
(12) Patent Application Publication
(10) Pub. No.: US 2003/0079873 A1
(43) Pub. Date: May 1, 2003

(54) Vehicle air conditioning system

(76) Inventor: Yasutaka Kuroda, Anjo-City (JP)

Correspondence Address: HARNESS, DICKEY & PIERCE, P.L.C., P.O. BOX 828, BLOOMFIELD HILLS, MI, 48303, US

(21) Appl. No.: 10/281,738

(22) Filed: Oct. 28, 2002

(30) Foreign Application Priority Data
Oct. 29, 2001 (JP) 2001-331251

(51) Int. Cl. B60H 3/00; B61D 27/00; F25B 29/00; B60H 1/00

(52) U.S. Cl. 165/202; 165/240; 165/42; 165/43; 237/2 B

(57) ABSTRACT

A vehicle air conditioning system prevents the air quality from an air conditioner from becoming worse and also prevents the manufacturing cost of heat exchangers such as an interior heat exchanger, from increasing. The vehicle air conditioning system allows a heat pump unit to be operated at the maximum heating ability within a limit of the pressure resistance of the interior heat exchanger when the hot water temperature is lower than a predetermined temperature. If the temperature of hot water is equal to or higher than a predetermined temperature, the heating ability of the heat pump unit decreases with an increasing temperature of the hot water. Thus, high-pressure refrigerant cannot continuously flow through the interior heat exchanger for a long time period, so that a sufficient pressure resistance can be obtained without excessively setting the pressure of the interior heat exchanger.

### CROSS REFERENCE TO RELATED APPLICATION

This application is based on, claims the benefit of priority of, and incorporates by reference the contents of prior Japanese Patent Application No. 2001-331251, filed on Oct. 29, 2001.

### BACKGROUND OF THE INVENTION

1. Field of the Invention

The present invention relates to a vehicle air conditioning system that includes a heat exchanger and a heater, where the heat exchanger is provided for heating the air to be blown into a vehicle compartment by means of a high-temperature refrigerant discharged from a compressor, and the heater is provided for using waste heat generated from an engine coolant (i.e., cooling water) or the like in the vehicle as a heat source.

2. Description of the Related Art

Heretofore, a heat-pump type air conditioning system includes an interior heat exchanger. When the system performs a cooling operation, the interior heat exchanger receives the flow of a low-temperature refrigerant being decompressed at low pressure. When the system is in a heating operation, on the other hand, it receives the flow of a high pressure, high-temperature refrigerant discharged from a compressor.

Therefore, the interior heat exchanger should be designed to have the ability to withstand the application of high pressure (i.e., pressure resistance). In this case, however, improving the pressure resistance of the interior heat exchanger will increase its manufacturing costs.

Furthermore, if the pressure resistance of the interior heat exchanger is set to a comparatively low resistance, there is the possibility of causing damage to the interior heat exchanger when a high-pressure refrigerant continuously passes through the interior heat exchanger for a long time. Therefore, there is a need to prevent the interior heat exchanger from being continuously kept at a high pressure for a long time by intermittently actuating the compressor at frequent intervals.

However, when the compressor is actuated at frequent intervals, it is highly likely that the feeling, which a vehicle interior occupant feels from the air conditioning air, becomes worse as the temperature to the air blowing out of the compressor varies over a short time period.

### SUMMARY OF THE INVENTION

In view of the above facts, therefore, an object of the present invention is to provide a vehicle air conditioning system capable of preventing the air conditioning feeling felt by a vehicle occupant from worsening during system cycling and from preventing the manufacturing cost of a heat exchanger such as an interior heat exchanger from increasing.

To attain the above object, in a first aspect of the present invention, a vehicle air conditioning system includes: an air conditioning casing (18) through which the air to be blown into a vehicle interior flows, a heat exchanger (15) in the air conditioning casing (18), in which a low-temperature decompressed refrigerant flows during a time of at least a cooling operation while a high-temperature refrigerant flows during a time of a heating operation to make a heat exchange between the refrigerant and the air, a heater (21) equipped in the air conditioning casing (18), which heats the air using waste heat generated by a vehicle as a heat source, and means for adjusting an amount of heating (25) to be applied to the air by the heat exchanger (15) and an amount of heating to be applied to the air by the heater (21) at the time of at least the heating operation. The means (25) for adjusting the amount of heating adjusts the amount of heating to be applied to the air by the heat exchanger (15) and the amount of heating to be applied to the air by the heater (21) on the basis of at least one of a temperature and an amount of the waste heat.

The vehicle air conditioning system is constructed as described above, so that the required heating ability of the system can be obtained without continuously flowing the high-pressure refrigerant into the heat exchanger (15) for a long time. Therefore, a sufficient pressure resistance (i.e., safety) of the heat exchanger (15) can be obtained without setting a proof pressure of the heat exchanger (15) to an extremely high pressure, and the manufacturing cost of the heat exchanger (15) can be maintained.

Furthermore, the amount of heating to be applied to the air by the heat exchanger (15) and the amount of heating to be applied to the air by the heater (21) are adjusted on the basis of at least one of the temperature and the amount of waste heat, respectively. Therefore, the temperature to the air blowing into the vehicle interior (i.e., the blowing air temperature) is set to almost the target blowing temperature without depending on variations in the waste heat and the pressure of the high-pressure refrigerant. Therefore, the blowing air temperature can be prevented from varying within a short time period so that the feeling felt by a person in the vehicle interior can be prevented from deteriorating. Additionally, according to the present invention as described above, the manufacturing cost of the heat exchanger, such as the interior heat exchanger, can be prevented from increasing while preventing the air feeling from deteriorating.

In a second aspect of the invention, a vehicle air conditioning system includes: an air conditioning casing (18) through which the air to be blown into a vehicle interior flows, a heat exchanger (15) within the air conditioning casing (18), in which a low-temperature decompressed refrigerant flows during a time of at least a cooling operation while a high-temperature refrigerant flows during a time of a heating operation to create a heat exchange between the refrigerant and the air. Furthermore, a second aspect provides, a heater (21) equipped in the air conditioning casing (18), which heats the air using waste heat generated in a vehicle as a heat source, and means (25) for adjusting an amount of heating, which adjusts an amount of heating to be applied to the air by the heat exchanger (15) and an amount of heating to be applied to the air by the heater (21) at the time of at least the heating operation. The means (25) for adjusting the amount of heating reduces the amount of heating to be applied to the air by the heat exchanger (15) depending on an increase in at least one of a temperature and an amount of the waste heat.

The vehicle air conditioning system is constructed as described above, so that a required heating ability of the system can be obtained without continuously flowing the high-pressure refrigerant into the heat exchanger (15) for a long time. Therefore, a sufficient pressure resistance of the heat exchanger (15) can be obtained without setting a proof pressure of the heat exchanger (15) to an extremely high pressure, and manufacturing costs of the heat exchanger (15) can be prevented from increasing.

Furthermore, the amount of heating to be applied to the air by the heat exchanger (15) and the amount of heating to be applied to the air by the heater (21) are adjusted on the basis of at least one of the temperature and the amount of waste heat, respectively. Therefore, the blowing air temperature is set to almost the target blowing temperature without depending on variations in the waste heat and the pressure of the high-pressure refrigerant. Therefore, the blowing air temperature can be prevented from varying within a short time period, so that the feeling to the air to a vehicle occupant can be prevented from deteriorating.

According to the present invention, as described above, the manufacturing cost of the heat exchanger such as the interior heat exchanger can be prevented from increasing while preventing the feeling to the air felt by passengers from deteriorating. Furthermore, the means (25) for adjusting the amount of heating reduces the amount of heating to be applied to the air by the heat exchanger (15) in accordance with an increase of at least one of the temperature and the amount of waste heat. Therefore, the compressor (11) can be prevented from needlessly working and power consumption of the compressor (11) can be reduced.

In a third aspect of the present invention, a vehicle air conditioning system includes an air conditioning casing (18) through which the air to be blown into a vehicle interior flows, a heat exchanger (15) equipped in the air conditioning casing (18), in which a low-temperature decompressed refrigerant flows in during at least a cooling operation while a high-temperature refrigerant flows in during a heating operation to exchange heat between the refrigerant and the air, a heater (21) within the air conditioning casing (18), which heats the air using waste heat generated in a vehicle as a heat source, and means (25) for adjusting an amount of heating, which adjusts an amount of heating to be applied to the air by the heat exchanger (15) and an amount of heating to be applied to the air by the heater (21) at the time of at least the heating operation. The means (25) for adjusting the amount of heating reduces the amount of heating to be applied to the air by the heat exchanger (15) depending on an increase in temperature of the waste heat when the temperature of the waste heat becomes higher than a predetermined temperature.

The vehicle air conditioning system is constructed as described above, so the required heating ability of the system can be obtained without continuously flowing the high-pressure refrigerant into and through the heat exchanger (15) for a long time. Therefore, a sufficient pressure resistance of the heat exchanger (15) can be obtained without setting a proof pressure of the heat exchanger (15) to an extremely high pressure, and a manufacturing cost of the heat exchanger (15) can be prevented from increasing.

Furthermore, the amount of heating to be applied to the air by the heat exchanger (15) and the amount of heating to be applied to the air by the heater (21) are adjusted on the basis of at least one of the temperature and the amount of waste heat, respectively. Therefore, the blowing air temperature is set to almost the target blowing temperature without depending on variations in the waste heat and the pressure of the high-pressure refrigerant. Therefore, the blowing air temperature can be prevented from varying within a short time period, so that the air feeling can be prevented from deteriorating.

According to the present invention, as described above, manufacturing cost of the heat exchanger such as the interior heat exchanger can be prevented from increasing while preventing the air quality from deteriorating. Furthermore, the means (25) for adjusting the amount of heating reduces the amount of heating to be applied to the air by the heat exchanger (15) in accordance with an increase in the temperature of waste heat. Therefore, the compressor (11) can be prevented from needlessly working and power consumption of the compressor (11) can be reduced.

Preferably, in a fourth aspect of the invention, the means (25) for adjusting the amount of heating may set a pressure of the refrigerant flowing in the heat exchanger (15) to a pressure resistance of the heat exchanger (15) or less when the temperature of the waste heat is lower than the predetermined temperature.

Preferably, in a fifth aspect of the invention, the means (25) for adjusting the amount of heating may set the pressure of the refrigerant flowing in the heat exchanger (15) to 9 MPa±1 MPa or less when the temperature of the waste heat is lower than the predetermined temperature.

Preferably, in a sixth aspect of the invention, the means (25) for adjusting the amount of heating may set a temperature of the refrigerant flowing in the heat exchanger (15) to 50° C.±20° C. or less.

Further areas of applicability of the present invention will become apparent from the detailed description provided hereinafter. It should be understood that the detailed description and specific examples, while indicating the preferred embodiment of the invention, are intended for purposes of illustration only and are not intended to limit the scope of the invention.

### BRIEF DESCRIPTION OF THE DRAWINGS

The present invention will become more fully understood from the detailed description and the accompanying drawings, wherein:

FIG. 1 is a schematic diagram showing the general configuration of a first embodiment of the present invention;

FIG. 2 is a flowchart representing the control flow of the first embodiment of the present invention;

FIG. 3 is a graph representing the relationship between the temperature efficiency and the air quantity;

FIG. 4 is a graph representing the relationship between the elapsed time and the blowing air temperature and so on;

FIG. 5 is a flowchart representing the control flow according to a second embodiment of the present invention; and

FIG. 6 is a flowchart representing the control flow of the second embodiment of the present invention.

### DETAILED DESCRIPTION OF THE PREFERRED EMBODIMENTS

The following description of the preferred embodiment(s) is merely exemplary in nature and is in no way intended to limit the invention, its application, or uses.

First Embodiment

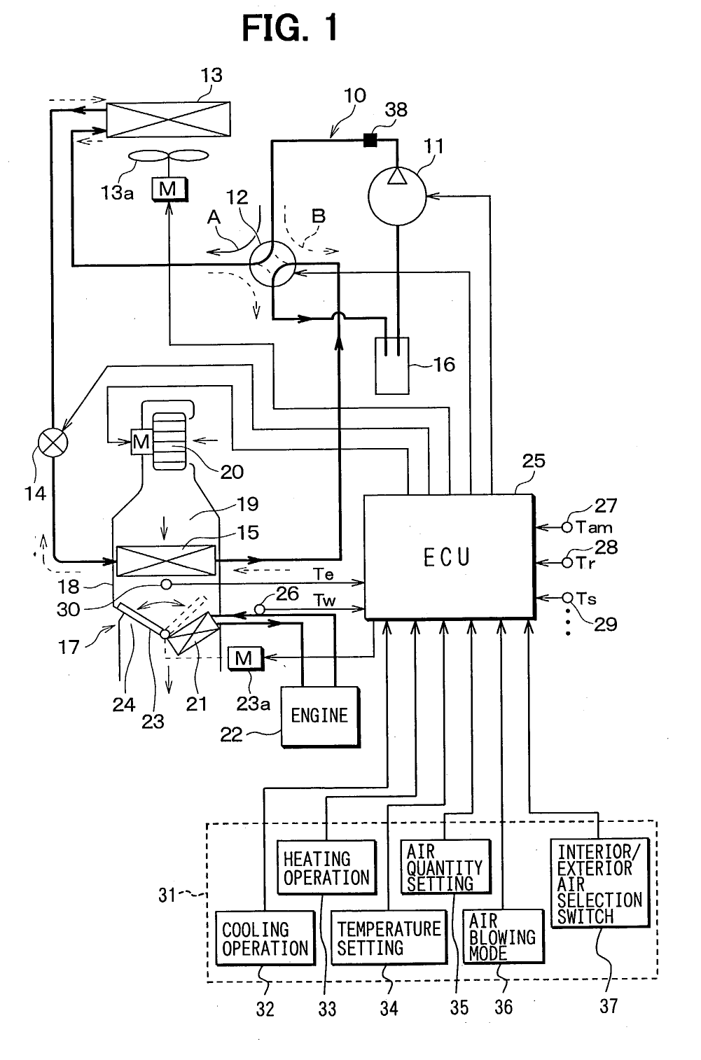

FIG. 1 is a general view of the configuration of an exemplified vehicle air conditioning system in accordance with a first embodiment of the present invention. In this embodiment, a heat pump unit 10 is configured to realize a refrigeration cycle and is capable of switching between a cooling operation and a heating operation.

Here, the heat pump unit 10 is configured to realize a supercritical refrigeration cycle in which carbon dioxide (CO₂) is used as a refrigerant. Such a supercritical refrigeration cycle is well known in the art, for example as described in Japanese National Publication No. Hei. 3-50326. The refrigerant on the high-pressure side may sometimes be used at a pressure higher than a supercritical pressure. In this case, the refrigerant on the high-pressure side releases heat without causing condensation thereof, while the refrigerant remains in gaseous form.

A compressor 11 is provided for inhaling and compressing the refrigerant by power obtained from a driving motor. In this embodiment, the compressor 11 is of a variable capacity type. Thus, the compressor 11 is capable of adjusting its discharge ability by varying a discharge capacity of the compressor 11 with the control of a duty ratio of the applied power to a control valve that controls pressure on the inside of a crank chamber.

A four-way valve 12 is provided for switching the flow direction of a refrigerant from one direction to another and vice versa with respect to each of the discharge and suction sides of the compressor 11 by controlling the orientation of a valve body (not shown) with an electric actuator mechanism. In the figure, the arrow A made with a solid line indicates the flow of refrigerant at the time of a cooling operation, while the arrow B made with a broken line indicates the flow of refrigerant at the time of a heating operation.

An external heat exchanger 13 is arranged in a vehicle engine room together with the compressor 11 and so on. The heat exchanger 13 is provided for exchanging heat between the outside air blowing through a motorized cooling fan 13a and the refrigerant fed from the compressor 11. During the cooling operation, the heat exchanger 13 acts on the high-pressure side. During the heating operation, on the other hand, the heat exchanger 13 acts on the low-pressure side.

A decompression device 14 is located between the external heat exchanger 13 and an interior heat exchanger 15. The decompression device 14 is provided for decompressing and expanding the refrigerant on the high-pressure side of the heat pump unit 10 to reduce the pressure of the refrigerant. Such a decompression device 14 is comprised of a variable aperture, for example, an electric expansion valve in which the opening of its aperture can be electrically adjusted.

An accumulator 16 is located between the four-way valve 12 and the intake side of the compressor 11. The accumulator 16 receives the refrigerant from the outlet of the interior heat exchanger 15 or the outlet of the external heat exchanger 13. The accumulator 16 separates a liquefied fraction from a gaseous fraction in the refrigerant to reserve the resulting liquefied refrigerant, followed by allowing the compressor 11 to draw in the gaseous refrigerant and refrigerating machine oil in the vicinity of the bottom of the accumulator 16.

An interior unit 17 on the vehicle air conditioning system includes an air conditioning casing 18 that constitutes an air passage 19 for allowing the air to flow to the inside of the vehicle interior. As shown in FIG. 1, an electric air conditioning fan 20 blows the air into the air conditioning casing 18. In addition, there is a switching box (not shown) equipped on the intake side of the air conditioning fan 20 to allow the air to be introduced from the inside or outside of the vehicle interior. In winter, for example, fresh air is usually introduced from the outside to the switching box for preventing the vehicle window glass from fogging during heating.

The interior heat exchanger 15 is arranged on the downstream side of the fan 20. During the cooling operation, the interior heat exchanger 15 is provided on the low-pressure side. In this case, the low-pressure refrigerant in the refrigeration cycle is introduced into the interior heat exchanger 15 and is then evaporated while absorbing heat from the air. As a result, the air blowing from the air conditioning fan 20 can be cooled. During the heating operation, on the other hand, the interior heat exchanger 15 becomes effective on the high-pressure side. In this case, the high-pressure gaseous refrigerant on the discharge side of the compressor 11 is directly introduced into the interior heat exchanger 15 and a stream of blowing air is then heated by the radiation of heat from the high-pressure gaseous refrigerant.

In the air conditioning casing 18, a heater core 21 is provided downstream of the air flow from the interior heat exchanger 15. The heater core 21 is a heat exchanger that utilizes hot water and is configured to heat a stream of blowing air using hot water circulated from a water-cooling type vehicle engine 22 (i.e., using the heated engine coolant from the engine 22) as a heat source.

An air-mixing door 23 is a means for adjusting the temperature of the air blowing into the vehicle interior. The air-mixing door 23 regulates an air-flow rate between the cold air passing through a bypass passage 24 of the heater core 21 and the hot air passing through the heater core 21. Furthermore, the air-mixing door 23 can be opened and closed by a driving device 23a comprised of a servo motor.

Downstream of the heater core 21 in the air conditioning casing 18, there is provided air-blowing apertures (not shown) from which the air for air conditioning can be blown into the vehicle interior. In general, as is commonly known, the air-blowing apertures may include a foot air-blowing aperture from which the air is blown to an occupant's feet, a face air-blowing aperture from which the air is blown to an occupant's face, and a defroster air-blowing aperture for blowing the air to the inner side of the vehicle window glass. Thus, air-blowing modes can be selectively switched by opening or closing each of these air nozzles with an air-blowing mode switching door (not shown).

An electric control unit (hereinafter, abbreviated as ECU) 25 for an air conditioning system is comprised of a microcomputer and its peripheral circuits. The ECU 25 performs an arithmetical operation on input signals in accordance with a predetermined program to control the rotation of the compressor 11, the switching of the four-way valve 12, and the operation of other pieces of electric equipment (13a, 14, 20, 23a, and so on).

The ECU 25 receives detection signals from sensors. Here, the sensors may include: a water-temperature sensor 26 for detecting the temperature Tw of hot water in the vehicle engine 22, an outside air temperature sensor 27, an inside air temperature sensor 28, a solar radiation sensor 29, a blowing-air temperature sensor 30 provided as a means for detecting the temperature of the interior heating exchanger 15, and so on.

In addition, the ECU 25 also receives operating signals from operating switches on an operating panel 31 for air conditioning. The operating panel 31 is arranged in the vicinity of a console in the vehicle interior. The operating switches may include: an air conditioning switch 32 for actuating the compressor 11 in the refrigeration cycle and for switching the four-way valve 12 of the cooling operation of the heat pump unit 10, a heating switch 33 for actuating the compressor 11 in the refrigeration cycle and switching the four-way valve 12 of the heating operation of the heat pump unit 10, a temperature setting switch 34 for setting a desired temperature of the vehicle interior, an air flow rate selecting switch 35, a blowing mode selecting switch 36, an outside and inside air selecting switch 37, and so on.

Hereinafter, the operation of the first embodiment, which is configured above, will be described.

1. Actuations of Components Responsible for the Refrigeration Cycle in the Heat Pump Unit 10

1.1. Cooling Operation

During the cooling operation, the ECU 25 actuates the four-way valve 12 to allow the refrigerant to flow along the passage represented by the solid line in the direction along the arrow A in FIG. 1. Thus, the gaseous refrigerant discharged from the compressor 11 can be fed into the external heat exchanger 13 after passing through the four-way valve 12.

In the external heat exchanger 13, the gaseous refrigerant can be cooled by the air blowing from the cooling fan 13a. If the heat load of the refrigerating cycle is heavy, the high-pressure refrigerant passing through the external heat exchanger 13 is brought to a supercritical state where the pressure of the refrigerant is higher than a supercritical pressure. In this state, therefore, the gaseous refrigerant dissipates heat without causing condensation thereof. On the other hand, if the heat load of the refrigerating cycle is low, the high-pressure refrigerant is brought to a low pressure state where the pressure of the refrigerant is lower than the supercritical pressure. In this state, therefore, the gaseous refrigerant becomes condensed in the external heat exchanger 13.

After passing through the external heat exchanger 13, the refrigerant is decompressed by the decompression device 14 comprised of an electric expansion valve. Then, the refrigerant is brought to a gas-liquid double phase state where both the gaseous and liquefied portions can be found in the decompressed refrigerant at a low temperature and a low pressure. Subsequently, the decompressed refrigerant flows into the interior heat exchanger 15 and absorbs heat from a stream of the air in the air conditioning casing 18. Thus, the decompressed refrigerant can be vaporized. The air being cooled in the interior heat exchanger 15 is blown into the vehicle interior to cool the inside of the vehicle interior. The gaseous refrigerant vaporized in the interior heat exchanger 15 passes through the four-way valve 12 and is then drawn into the compressor 11 through the accumulator 16, which results in a compression of the refrigerant.

1.2. Heating Operation

During the heating operation, the ECU 25 actuates the four-way valve 12 to allow the refrigerant to flow along the dashed line of arrow B in FIG. 1. Thus, the gaseous refrigerant discharged from the compressor 11 can be fed into the interior heat exchanger 15 after passing through the four-way valve 12. In the interior heat exchanger 15, therefore, the discharged gaseous refrigerant dissipates heat into the air flowing in the air conditioning casing 18 to heat the air blown into the vehicle interior.

After passing through the interior heat exchanger 15, the refrigerant is decompressed by the decompression device 14 and is then brought to the gas-liquid double phase state at a low temperature and low pressure. The low-pressure refrigerant absorbs heat from a stream of the outside air in the external heat exchanger 13. Then, the gaseous refrigerant vaporized in the external heat exchanger 13 passes through the four-way valve 12 and is then drawn into the compressor 11 through the accumulator 16. In the interior heat exchanger 15, furthermore, the amount of heat released from the gaseous refrigerant is equal to the sum of the amount of heat absorbed in the external heat exchanger 13 and the compression work load of the compressor 11.

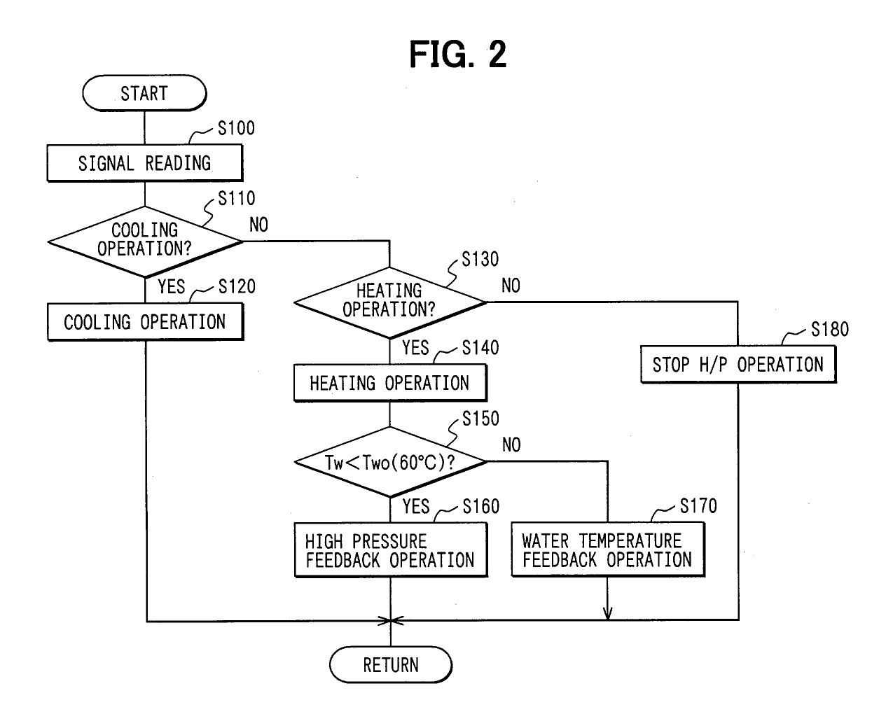

Next, the control of the heat pump unit 10 in accordance with the flow chart shown in FIG. 2 will be described. An ignition switch (not shown) of the vehicle engine 22 is turned on. Then, the heat pump unit 10 is initiated to read signals from the respective sensors 26 to 30 and the respective operating switches 32 to 37 to the air conditioning operating panel 31 (S100).

Subsequently, depending on the position of the air conditioning switch 32, a judgment is made whether a cooling operation is set (S110). If the cooling operation is set, the compressor 11 is actuated and the four-way valve 12 is switched to a cooling state represented by the solid line in FIG. 1 to perform the cooling operation (S120).

On the other hand, when the cooling operation is not set, depending on the position of the heating switch 33, a judgment is made whether a heating operation is set (S130). Then, if the heating operation is set, the compressor 11 is actuated and the four-way valve 12 is switched to a heating state represented by the dashed line in FIG. 1 to perform the heating operation (S140).

Next, a judgment is made whether the temperature Tw of hot water detected by the water temperature sensor 26 is lower than the predetermined temperature Two (in this embodiment, 60° C.) (S150). If the temperature Tw of the hot water is lower than the predetermined temperature Two, then high-pressure feedback control is performed (S160).

Here, the high-pressure feedback control means that the discharge capacity of the compressor 11 is subjected to feedback control such that the discharge pressure of the compressor 11 becomes a proof pressure (in this embodiment, 10 MPa) of the interior heat exchanger 15 by incorporating signals from a pressure sensor 38 located on the discharge side of the compressor 11 in order to prevent the interior heat exchanger 15 from being damaged.

On the other hand, if the temperature Tw of the hot water is higher than the predetermined temperature Two, then it becomes possible to attain sufficient heating ability by waste heat from the engine (i.e., only by the heating core 21). That is, it eliminates the need for actuating a heat pump in the refrigeration cycle. Therefore, the feedback control is performed on the water temperature to improve the coefficient of performance (COP) of the refrigeration cycle (S170).

Here, the water temperature feedback control means that the discharge capacity of the compressor 11 is controlled such that the temperature of the air blowing into the vehicle interior becomes a target blowing temperature in consideration of the amount of heating from the heater core 21 to the air.

In other words, the above control can be represented by the following mathematical expressions (1) and (2).

Va·Cpa·Φ·(Tw−Ta2)=Va·Cpa·(Ta3−Ta2) (1)

where:

Ta2 denotes the temperature of the air directly after passing through the interior heat exchanger 15;

Ta3 denotes the target blowing temperature, i.e., the temperature of the air immediately after passing through the heater core 21;

Va denotes the quantity of air passing through the interior heat exchanger 15 and the heater core 21;

Cpa denotes the specific heat of air at constant pressure; and

Φ denotes the temperature effectiveness of the heater core 21.

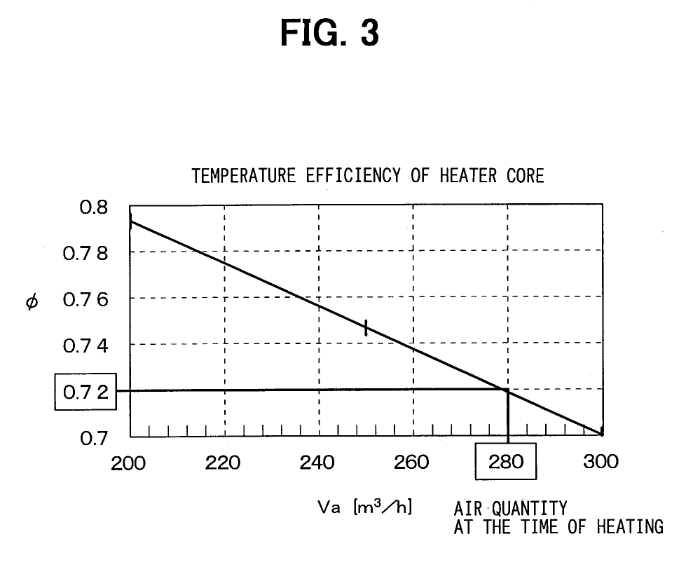

As shown in FIG. 3, the temperature effectiveness q) of the heater core 21 can be also approximated using a linear function of the quantity Va of air in the heating operation.

The equation (1) can be alternatively represented by the following equation (2).

Ta2=(Ta3−Φ·Tw)/(1−Φ) (2)

Therefore, the temperature Ta2 of air immediately after passing through the interior heat exchanger 15 can be decreased by increasing the temperature of hot water Tw. If the temperature Tw of hot water is higher than the predetermined temperature Two, the amount of heat applied to the air by the interior heat exchanger 15 on the basis of the equation (2) decreases by increasing the temperature Tw of hot water. Thus, the target temperature Ta2 of the air decreases when the temperature Tw of hot water exceeds the target blowing temperature Ta3. Eventually, the heat pump unit 10 stops, so that the heating operation can only be performed by the heater core 21.

On the other hand, if the engine, and heat pump 10, is changed from a driving state to an idling state, the temperature Tw of the hot water decreases as the load on the engine 22 decreases, while the amount of heat applied to the air by the heat exchanger 15 is in accordance with the above equation (2). Furthermore, if it is judged that the heating operation is not set in step S130, then the compressor 11 is brought into a resting state to stop the heat pump unit 10 in step S180.

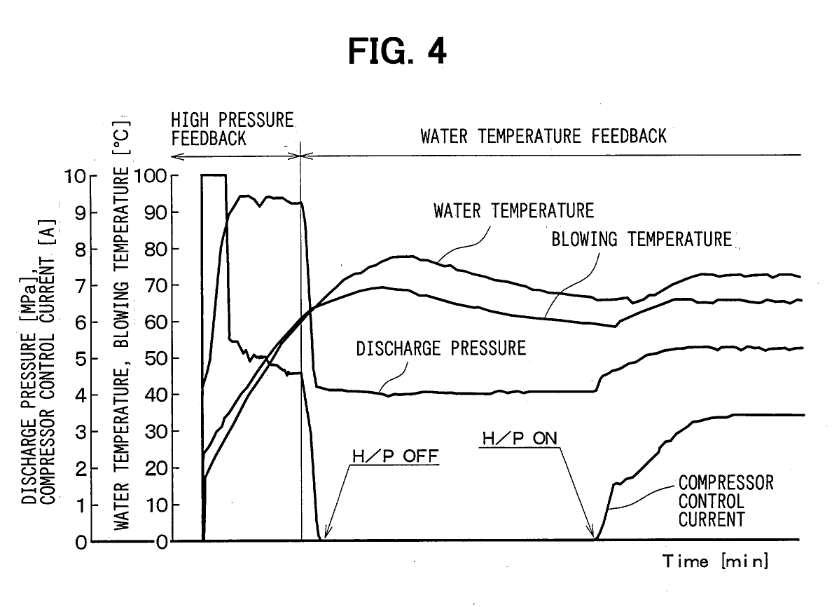

In FIG. 4, there is shown the results of performing both the high-pressure feedback and water-temperature feedback controls on the discharge capacity of the compressor 11. That is, the high-pressure feedback control is performed for several minutes from the actuation of the engine 22 to the time at which the temperature Tw of the hot water reaches to 60° C. Subsequently, the control changes from high-pressure feedback to water-temperature feedback, so that the control current of the compressor 11 gradually decreases and stops the heat pump unit 10. In a short time, the temperature Tw of the hot water decreases, so that the heat pump unit 10 again actuates to compensate for the heating ability of the compressor 11 by compensating for the deficiency with waste heat of the engine.

Hereinafter, we will describe the actions and effects of the present embodiment. According to the present embodiment, if the temperature Tw of hot water is lower than the predetermined temperature Two, then the heat pump unit 10 is operated at the maximum heating ability within a limit of pressure resistance of the interior heat exchanger 15. If the temperature Tw of hot water is equal to or higher than the predetermined temperature Two, on the other hand, then the high-pressure refrigerant does not flow continuously into the interior heat exchanger 15 for a long time period.

Therefore, manufacturing costs of the interior heat exchanger 15 can be prevented from increasing. Additionally, the required but sufficient pressure-resisting ability (i.e., safety) of the interior heat exchanger 15 can be obtained, without setting the proof pressure of the interior heat exchanger 15 to an extremely high pressure.

Furthermore, the amount of heat to be applied to the air by the interior heat exchanger 15 and the amount of heating to be applied to the air by the heater core 21 are controlled on the basis of the predetermined temperature Two. Without depending on the pressure of the high-pressure refrigerant, variations in the temperature Tw of hot water, and the discharge pressure of the compressor 11, the temperature of air blowing into the vehicle interior can be set to almost the target blowing temperature Ta3. Therefore, since the blowing air temperature can be prevented from varying within a short time period, the air conditioning quality, or the feeling experienced by a person in contact with the air, can also be prevented from becoming worse.

According to the present embodiment, as described above, a manufacturing cost of the heat exchanger such as the interior heat exchanger can be prevented from becoming increased while preventing the air conditioning feeling from becoming worse.

Furthermore, if the temperature Tw of hot water is higher than the predetermined temperature Two, the heating ability of the heat pump unit 10 decreases by increasing the temperature Tw of hot water. The compressor 11 can be prevented from needlessly working and power consumption of compressor 11 can be reduced. Consequently, the fuel efficiency of the vehicle can be improved.

Second Embodiment

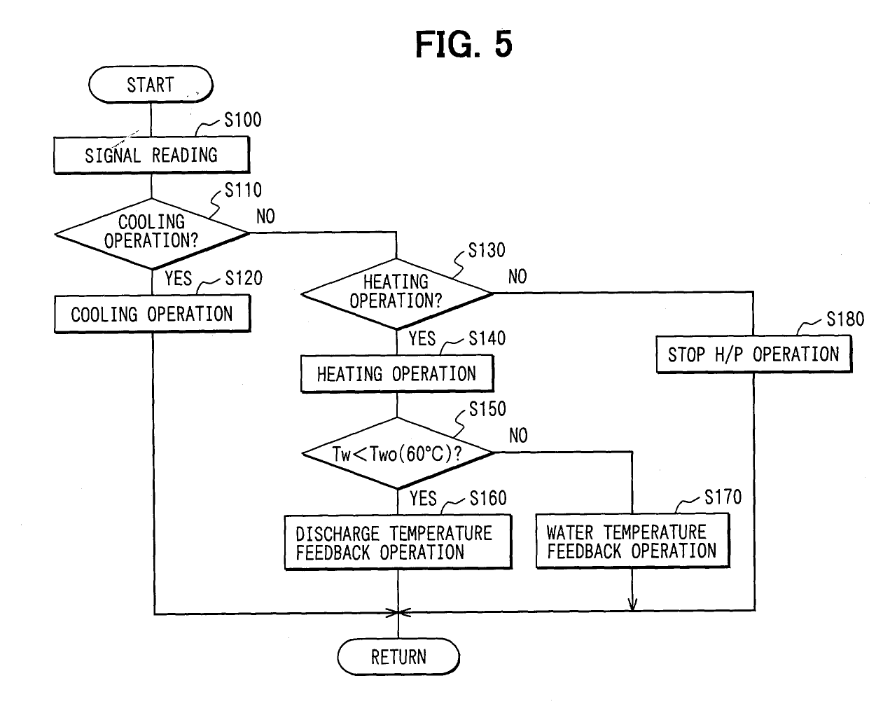

FIG. 5 is a flowchart representing a flow control of the heat pump unit 10 in the heating operation in accordance with a second embodiment. In the first embodiment (see FIG. 2), as described above, high-pressure feedback control is performed in step S160. In this embodiment, on the other hand, a discharge-temperature feedback control is performed in the step S160 as the pressure of the refrigerant shows a correlation with the temperature of the refrigerant. Therefore, the second embodiment is designed to perform a discharge-temperature feedback control in step S160.

Here, the discharge-temperature feedback control means that the discharge capacity of the compressor 11 is subjected to feedback control such that signals from a refrigerant temperature sensor (not shown) mounted on the discharge side of the compressor 11 are incorporated. Furthermore, the temperature of the refrigerant, which is discharged from the compressor 11 and is then introduced into the interior heat exchanger 15, becomes a temperature (e.g., 100° C.) that corresponds to the proof pressure of the interior heat exchanger 15.

Third Embodiment

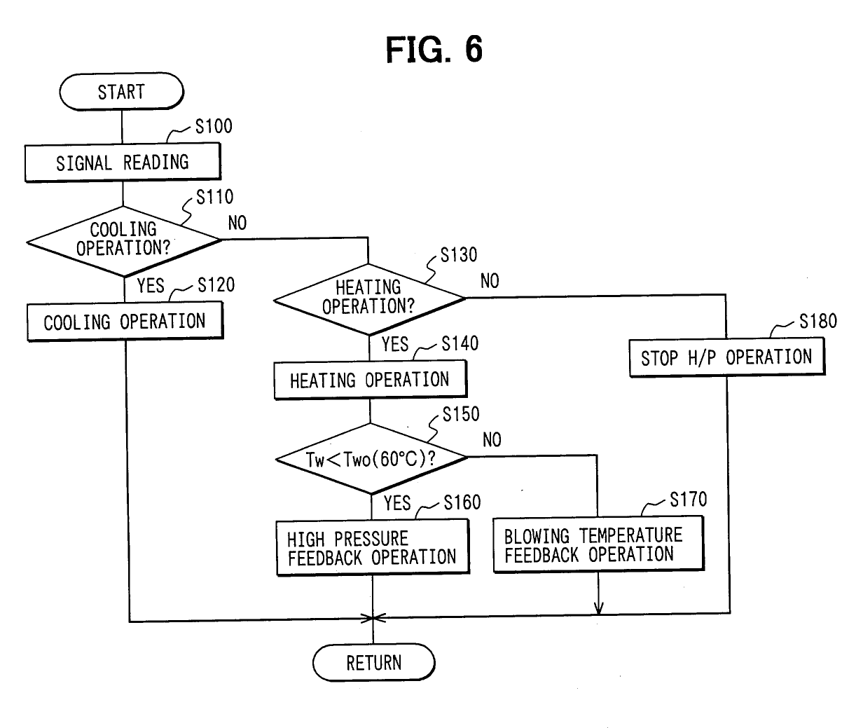

FIG. 6 is a flowchart for representing a control flow of the heat pump unit 10 in the heating operation in accordance with a third embodiment. In the first embodiment (see FIG. 2), as described above, the water-temperature feedback control is performed in step S170. As is evident from equation (2), the temperature Ta2 of air immediately after passing through the interior heat exchanger 15 shows a correlation with the target blowing temperature Ta3. In this embodiment, therefore, blowing-temperature feedback control is performed in step S170.

Here, the blowing-temperature feedback control means that signals are incorporated from a temperature sensor (not shown) for detecting the temperature of air having passed through the interior heat exchanger 15. Furthermore, the discharge capacity of the compressor is subjected to feedback control such that the detected temperature of the temperature sensor becomes the target blowing temperature Ta3 (e.g., 60° C.).

Other Embodiments

In each of the first to third embodiments described above, the compressor 11 is designed to be driven by the drive motor. According to the present invention, however, it is not limited to such a driving method. Alternatively, the compressor 11 may be designed to be driven by an electric motor such that the flow rate of a discharged refrigerant can be controlled by way of adjusting the rotation (rpm) of the electric motor.

Furthermore, in each of the above embodiments, carbon dioxide (CO₂) is used as the refrigerant. However, the present invention is not limited to such a refrigerant. Alternatively, the refrigerant may be one of other refrigerants, for example hydrocarbon refrigerants such as chlorofluorocarbon, ethylene, ethane, nitrogen oxide, and propane.

Furthermore, the present invention is not limited to each of the above embodiments. Alternatively, for example, an additional embodiment may be provided as a combination of the second and third embodiments.

In each of the above embodiments, there is no description about a defrosting operation. According to the present invention, a defrosting operation may be performed on the assumption that frost forms in the external heat exchanger 13 after a lapse of predetermined time To (e.g., 20 seconds) from the time of initiating the heating operation. In other words, the defrosting operation may be performed to flow the high-pressure refrigerant into the external heat exchanger 13.

During the defrosting operation, the predetermined time To may be shortened as the external temperature decreases. When the heating operation is stopped in progress, the defrosting time may be performed when the cumulative elapsed time including the elapsed time before the stop reaches the predetermined time To.

In each of the embodiments described above, the engine coolant (i.e., cooling water) is used as a source of waste heat that is generated in the vehicle. However, the present invention is not limited to such a coolant. Alternatively, waste heat may be generated from internal combustion exhaust gas or other system. Additionally, a fuel cell may be used as a heat source.

The description of the invention is merely exemplary in nature and, thus, variations that do not depart from the gist of the invention are intended to be within the scope of the invention. Such variations are not to be regarded as a departure from the spirit and scope of the invention.

What is claimed is:

1. A vehicle air conditioning system, comprising:
an air conditioning casing that channels air toward a vehicle interior;
a heat exchanger enclosed within the air conditioning casing, in which a low-temperature decompressed refrigerant flows during at least a cooling operation while a high-temperature refrigerant flows during a heating operation to exchange heat between the refrigerant and air;
a heater enclosed within the air conditioning casing, wherein the heater heats the air using waste vehicle heat; and
means for adjusting an amount of heating, which adjusts an amount of heating to be applied to the air by the heat exchanger and an amount of heating to be applied to the air by the heater during at least a heating operation, wherein
the means for adjusting an amount of heating adjusts the amount of heating to be applied to the air by the heat exchanger and the amount of heating to be applied to the air by the heater on a basis of at least one of a temperature and a quantity of the waste heat.

2. A vehicle air conditioning system, comprising:
an air conditioning casing through which air to be blown into a vehicle interior flows;
a heat exchanger located within the air conditioning casing, in which a low-temperature decompressed refrigerant flows during at least a cooling operation while a high-temperature refrigerant flows during a heating operation to exchange heat between the refrigerant and the air;
a heater equipped in the air conditioning casing, which heats the air using waste heat generated in a vehicle; and
means for adjusting an amount of heat, which adjusts an amount of heat to be applied to the air by the heat exchanger and an amount of heat to be applied to the air by the heater during at least the heating operation, wherein
the means for adjusting the amount of heat reduces the amount of heat to be applied to the air by the heat exchanger depending on an increase in at least one of a temperature and a quantity of the waste heat.

3. A vehicle air conditioning system, comprising:
an air conditioning casing through which air to be blown into a vehicle interior flows;
a heat exchanger located within the air conditioning casing, in which a low-temperature decompressed refrigerant flows during at least a cooling operation while a high-temperature refrigerant flows during a heating operation to exchange heat between the refrigerant and the air;
a heater located within the air conditioning casing, wherein the heater heats the air using waste heat generated by a vehicle; and
means for adjusting an amount of heating, which adjusts an amount of heating to be applied to the air by the heat exchanger and an amount of heating to be applied to the air by the heater during at least the heating operation, wherein
the means for adjusting the amount of heating reduces the amount of heating to be applied to the air by the heat exchanger depending on an increase in a temperature of the waste heat when the temperature of the waste heat becomes higher than a predetermined temperature.

4. The vehicle air conditioning system according to claim 3, wherein
the means for adjusting the amount of heating sets a pressure of the refrigerant flowing in the heat exchanger to a pressure resistance of the heat exchanger, or less.

5. The vehicle air conditioning system according to claim 3, wherein
the means for adjusting the amount of heating sets a pressure of the refrigerant flowing in the heat exchanger to 9 MPa±1 MPa or less when the temperature of the waste heat is lower than the predetermined temperature.

6. The vehicle air conditioning system according to claim 3, wherein
the means for adjusting the amount of heating sets a temperature of the refrigerant flowing in the heat exchanger to 50° C.±20° C. or less.
